(19) United States
(12) Patent Application Publication
(10) Pub. No.: US 2023/0364998 A1
(43) Pub. Date: Nov. 16, 2023

(54) CONTROL OF TRACTION BATTERY BASED ON TAB TEMPERATURE

(71) Applicant: FORD GLOBAL TECHNOLOGIES, LLC, Dearborn, MI (US)

(72) Inventors: Monty ANDERSON, Boise, ID (US); William Robert BROWN, Huntington Woods, MI (US); Nicholas FAVA, Troy, MI (US); Justin BARSANO, Hazel Park, MI (US); Zachary MARCH, Highlands Ranch, CO (US); Elaine CHEN, Dearborn, MI (US)

(21) Appl. No.: 17/740,610

(22) Filed: May 10, 2022

(51) Int. Cl. B60L 3/00; B60L 58/24; H01M 50/533; H01M 50/204

(52) U.S. Cl. CPC B60L 3/0046; B60L 58/24; H01M 50/533; H01M 50/204; H01M 2220/20

(57) ABSTRACT

A power system for a vehicle includes a controller that alters an amount of power output from a traction battery according to a magnitude of current passing through a tab of a cell of the traction battery, a temperature, and a distance between a location at which the temperature is measured and the tab.

### TECHNICAL FIELD

The present disclosure relates to a method and system for estimating a battery cell tab temperature of an electric vehicle.

### BACKGROUND

Electric vehicles rely on one or more high-voltage (HV) battery packs to provide electric power for propulsion. The battery pack may include a plurality of battery cells connected to each other via cell tabs.

### SUMMARY

A vehicle has a battery including a plurality of cells connected via one or more cell tabs, a motor, and a controller. The controller, responsive to data describing a temperature of the one or more cell tabs exceeding a threshold, decreases power output from the battery to the motor, wherein the data includes parameters indicative of a cell temperature of one of the plurality of cells, a resistance of the one or more cell tabs, and a thermal resistivity of one or more components other than the one or more cell tabs and the cells.

A method includes altering an amount of power output from a traction battery of a vehicle according to a resistance of one or more cell tabs of battery cells of the traction battery, current passing through the one or more cell tabs, a temperature, and a distance between a location at which the temperature is measured and the one or more cell tabs.

A power system for a vehicle a controller programmed to alter an amount of power output from a traction battery according to a magnitude of current passing through a tab of a cell of the traction battery, a temperature, and a distance between a location at which the temperature is measured and the tab.

### BRIEF DESCRIPTION OF THE DRAWINGS

FIG. 1 illustrates an example block topology of an electrified vehicle illustrating drivetrain and energy storage components.

FIG. 2 illustrates an example block diagram of a battery cell tab thermal model.

FIG. 3 illustrates an example flow diagram for a battery power mitigation process based on the battery cell tab temperature.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure proposes a method and system for measuring/estimating a battery cell tab temperature of an electric vehicle battery.

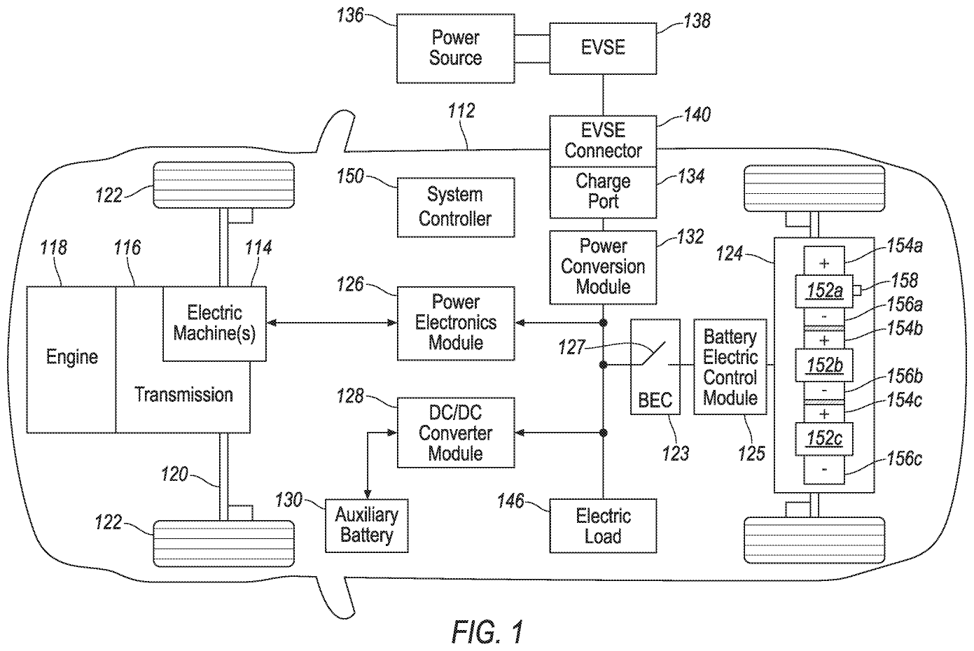

FIG. 1 illustrates a plug-in hybrid-electric vehicle (PHEV). A plug-in hybrid-electric vehicle 112 may include one or more electric machines (electric motors) 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft 120 that is mechanically coupled to the wheels 122. The electric machines 114 may provide propulsion and brake capability when the engine 118 is turned on or off. The electric machines 114 may also act as generators and may provide fuel economy benefits by recovering energy that would be lost as heat in the friction braking system. The electric machines 114 may also reduce vehicle emissions by allowing the engine 118 to operate at more efficient speeds and allowing the hybrid-electric vehicle 112 to be operated in electric mode with the engine 118 off under certain conditions.

A traction battery or battery pack 124 stores energy that may be used by the electric machines 114. A vehicle battery pack 124 may provide a high voltage DC output. The traction battery 124 may be electrically coupled to one or more battery electric control modules (BECM) 125. The BECM 125 is also known as the battery management system (BMS) 125. The BECM 125 may be provided with one or more processors and software applications configured to monitor and control various operations of the traction battery 124. The traction battery 124 may be further electrically coupled to one or more power electronics modules 126. The power electronics module 126 may also be referred to as a power inverter. One or more main contactors/switches 127 may be provided between the traction battery 124 and the power electronics modules 126 and configured to connect and isolate the battery 124 from the rest of the vehicle 112. The main contactors 127 may be configured to isolate the traction battery 124 and the BECM 125 from other components when opened and couple the traction battery 124 and the BECM 125 to other components when closed. The power electronics module 126 may also be electrically coupled to the electric machines 114 and provide the ability to bi-directionally transfer energy between the traction battery 124 and the electric machines 114. For example, a traction battery 124 may provide a DC voltage while the electric machines 114 may operate using a three-phase AC current. The power electronics module 126 may convert the DC voltage to a three-phase AC current for use by the electric machines 114. In a regenerative mode, the power electronics module 126 may convert the three-phase AC current from the electric machines 114 acting as generators to the DC voltage compatible with the traction battery 124. The description herein is equally applicable to a pure electric vehicle. For a pure electric vehicle, the hybrid transmission 116 may be a gear box connected to the electric machine 114 and the engine 118 may not be present.

In addition to providing energy for propulsion, the traction battery 124 may provide energy for other vehicle electrical systems. A vehicle may include a DC/DC converter module 128 that converts the high voltage DC output of the traction battery 124 to a low voltage DC supply that is compatible with other low-voltage vehicle loads. An output of the DC/DC converter module 128 may be electrically coupled to an auxiliary battery 130 (e.g., 12V battery).

The vehicle 112 may be a battery electric vehicle (BEV) or a plug-in hybrid electric vehicle (PHEV) in which the traction battery 124 may be recharged by an external power source 136. The external power source 136 may be a connection to an electrical outlet. The external power source 136 may be an electrical power distribution network or grid as provided by an electric utility company. The external power source 136 may be electrically coupled to electric vehicle supply equipment (EVSE) 138. The EVSE 138 may provide circuitry and controls to manage the transfer of energy between the power source 136 and the vehicle 112. The external power source 136 may provide DC or AC electric power to the EVSE 138. The EVSE 138 may have a charge connector 140 for plugging into a charge port 134 of the vehicle 112. The charge port 134 may be any type of port configured to transfer power from the EVSE 138 to the vehicle 112. The charge port 134 may be electrically coupled to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 112. The EVSE connector 140 may have pins that mate with corresponding recesses of the charge port 134. Alternatively, various components described as being electrically coupled may transfer power using a wireless inductive coupling.

One or more electrical loads 146 may be coupled to the high-voltage bus. The electrical loads 146 may have an associated controller that operates and controls the electrical loads 146 when appropriate. Examples of electrical loads 146 may be a heating module, an air-conditioning module, or the like.

The various components discussed may have one or more associated controllers to control and monitor the operation of the components. The controllers may communicate via a serial bus (e.g., Controller Area Network (CAN)) or via discrete conductors. A system controller 150 may be present to coordinate the operation of the various components. For instance, the system controller 150 may include a powertrain control module (PCM) configured to operate the powertrain of the vehicle 112. It is noted that the system controller 150 is used as a general term and may include one or more controller devices configured to perform various operations in the present disclosure. For instance, the system controller 150 may be programmed to enable a powertrain control function to operate the powertrain of the vehicle 112. The system controller 150 may be further programmed to enable a telecommunication function with various entities (e.g. a server) via a wireless network (e.g. a cellular network).

The traction battery 124 may include a plurality of battery cells 152 connected to each other via one or more battery cell tabs. As illustrated in FIG. 1, a first battery cell 152a may include a first anode cell tab 154a and a cathode cell tab 156a; a second battery cell 152b may include a second anode cell tab 154b connected to the first cathode cell tab 156a of the first battery cell 152 and a second cathode cell tab 156b; and a third battery cell 152c may include a third anode cell tab 154c connected to the second cathode cell tab 156b of the second battery cell 152b and a third cathode cell tab 156c. Although the battery cells 152 are connected in series in the present example illustrated with reference to FIG. 1, the present disclosure is not limited thereto and any other connection configurations as required by the specific design may be covered by the present disclosure under essentially the same concept. Further, although the cell tabs 154, 156 of different cells are directly connected to each other in the present example, intermediary materials (e.g. cable, harness, busbars) may be applied to the present disclosure under essentially the same concept.

The system controller 150 and/or BECM 125, individually or combined, may be programmed to perform various operations with regard to the traction battery 124 and/or the main contactors 127. For instance, the system controller 150 and/or BECM 125 may be configured to measure and estimate the temperature cell tabs based on various factors such as the battery temperature. The traction battery pack 124 may be provided with one or more temperature sensors 158 configured to measure the temperature of the battery cells 152. The temperature sensor 158 may be implemented in various manners. For instance, the temperature sensors 158 may include one or more thermistors configured to measure the temperature of the battery cells 152 using the resistance of a resistor. As illustrated in FIG. 1, a temperature sensor 158 may be located near the first battery cell 152a to measure the temperature of the first cell 152a. Due to various reasons, it may be impractical to provide each battery cell 152 with a separate temperature sensor 158. Therefore, the number of temperature sensors 158 may be significantly less than the number of battery cells 152. If multiple temperature sensors 158 are provided, the system controller 150 and/or BECM 125 may determine a single battery temperature using the multiple readings (e.g. an average temperature).

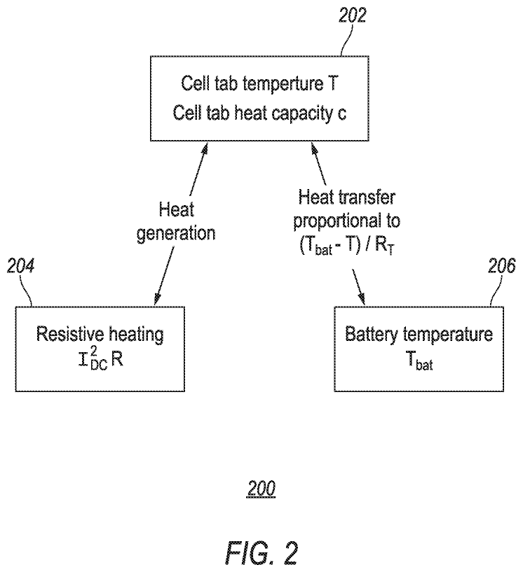

Referring to FIG. 2, an example block diagram 200 of a battery cell tab thermal model is illustrated. With continuing reference to FIG. 1, the thermal characteristics of the battery cell tabs 154, 156 may be represented by various factors. As illustrated with reference to box 202, the thermal characteristics 202 of the cell tabs 154, 156 may include one or more cell tab temperatures T. The thermal characteristics 202 may further include the heat capacity c indicative of the amount of heat to be supplied to each of the cell tabs 154, 156 to produce a unit change in the temperature T. The heat capacity c may be represented in units of joules per kelvin (J/K) or joule per degree Celsius (J/° C.). The heat capacity c of the cell tabs 154, 156 may be known/predetermined under the current thermal model. The cell tab temperature T may be affected by various factors depending on the operation condition of the vehicle 112. For instance, the cell tab temperature T may be affected by the resistive heating 204 represented by I_{DC}²R, wherein Inc denotes a direct current (DC) input or output from the traction battery 124 and R denotes the electrical resistance of a single one of the cell tabs 154, 156. The cell tab temperature T may be further associated with a battery temperature T_{bat} 206. The battery temperature T_{bat} may be indicative of a temperature of one or more battery cells 152 that is used as a reference in the present thermal model 200. In one example, the battery temperature T_{bat} may be directly measured by the one or more temperature sensors 158. Alternatively, the battery temperature T_{bat} may be a derived/estimated value. The heat generated by the traction battery cells 152 during the operation of the vehicle 112 may be transferred to the cell tabs 154, 156 in a proportion represented by (T_{bat}−T)/R_{T}, wherein R_{T} denotes the thermal resistivity between one or more battery tabs at which the temperature T is estimated and the traction battery cell 152 at which T_{bat} is measured in units of degrees per watt (° C./W). The thermal resistivity R_{T} may reflect the thermal resistivity of one or more components on the respective thermal communication paths. For instance, the thermal resistivity R_{T} may be affected by the housing/packing of the battery pack 124, the cooling and ventilation of the battery, and the distance between the temperature sensor 158 and the cell tabs 154, 156.

The vehicle 112 may use the thermal model 200 illustrated with reference to FIG. 2 to estimate the temperature of the cell tabs 154, 156 and perform vehicle operations controls accordingly. The thermal model 200 may be governed by the following equation (1):

\dot{T}c=T_{bat}−T)/R_{T}+I_{DC}²I_{DC}²R (1)

wherein \dot{T}c denotes the derivative of the cell tab heat capacity with respect to time in units of joules per kelvin (J/K). Once the thermal time constant α is considered, equation (1) may be rearranged and developed into equation (2) below:

\dot{T}+αT=α(T_{Bat}+I_{DC}²RR_{T}) (2)

wherein \dot{T} denotes the derivative of the cell tab temperature T with respect to time in units of degrees Celsius per second (° C./s). R_{T} denotes the thermal resistivity between the one or more cell tabs 154, 156 having the temperature of T and the cell at which the temperature T_{bat} is measured in units of degrees per watt. RR_{T} denotes a bulk resistivity obtained by R*R_{T1} in units of degrees per square amps (° C./A²). The inverse time constant α of the cell tabs may be calculated using the following equation (3):

α=1/cR_{T} (3)

In one example of the present disclosure, the a may be approximately 0.0014 (s⁻¹) and RR_{T} may be approximately 0.0008 (K/A²). With the time taken into account, the cell table estimated temperature T may be represented by equation (4):

T(t)=T(0)e^{-αt}+αe^{-αt}∫e^{αt}(T_{bat}(t)+I_{DC}²(t)RR_{T})dt (4)

Based on equation (4) above, a discrete version of the solution inside the vehicle control software may be implemented as equation (5) below:

T(tⱼ)=T(tⱼ₋₁)C_{TD}+gⱼ(1−C_{TD}) (5)

wherein e denotes the Euler constant. tⱼ denotes the time at the present calculation in units of seconds and tⱼ₋₁ denotes the time at the previous calculation in units of seconds. g denotes a target temperature of the one or more cell tabs 154, 156 in units of degrees Celsius (° C.) as the cell tab temperature estimate will continuously decay towards this estimated value which is updated each iteration. The target temperature g at the present iteration j may be represented by the following equation (6):

gⱼ=T_{bat}(tⱼ)+I_{DC}²(tⱼ)RR_{T} (6)

C_{TD} denotes in the above equation (5) the coefficient of thermal decay for the one or more cell tabs 154, 156 and in the present example may represented below:

$${C}_{TD} = \{ \begin{matrix}1 & if λ \leq 0 \\ 1 - λ & if 0 < λ < 0.1 \\ 0.81 / ( λ + 0.8 ) & if 0.1 \leq λ\end{matrix} \qquad ( 7 )$$

wherein λ denotes an intermediate variable that may be determined by the following equation:

λ=αΔt (8)

wherein Δt denote the timestep between the current and the previously time iteration calculated by:

Δt=tⱼ−tⱼ₋₁ (9)

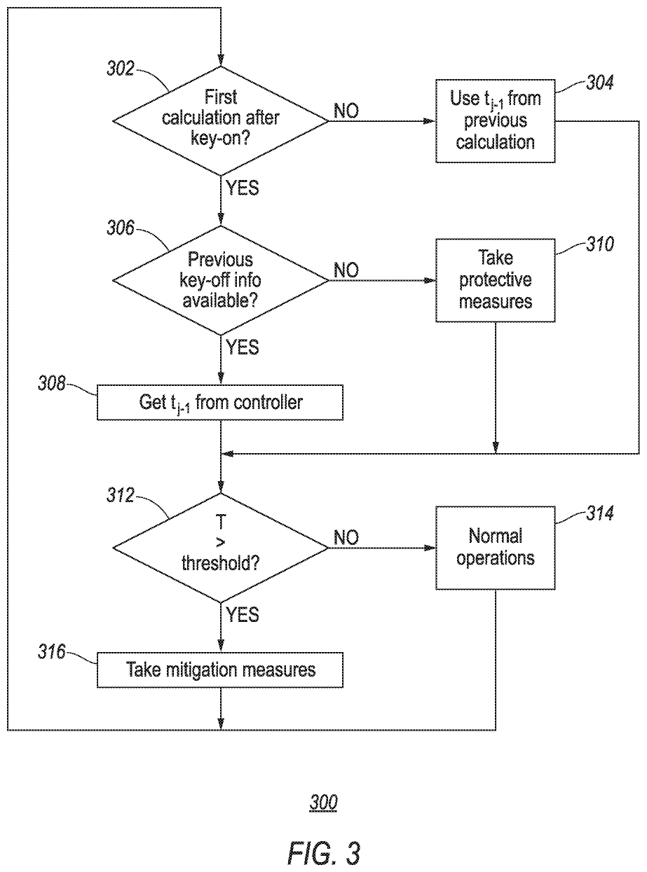

Referring to FIG. 3, an example flow diagram for a vehicle battery power mitigation process 300 based on the cell tab temperature is illustrated. With continuing reference to FIGS. 1 and 2, the process 300 may be individually or collectively implemented by the system controller 150 and/or the BECM 125. For simplicity purposes, the following description will be made with reference to the system controller 150. At operation 302, the system controller 150 verifies if the time tⱼ for the current cycle is the first calculation cycle after a vehicle key-on. In other words, the system controller 150 from the previous estimation tⱼ₋₁ for the current cycle processing based on equation (5) discussed above. Otherwise, if the answer for operation 302 is Yes indicative of a first calculation cycle, the process proceeds to operation 306 and the system controller 150 verifies if the data from a previous key-off event is available (e.g. stored in a storage device when the vehicle is shut down). The system controller 150 may be configured to store those data in the storage responsive to a key-off event such that the parameters may be used for future reference when the vehicle is started the next time. If those data entries are available, the process proceeds to operation 308 and the system controller 150 loads the data from the last key-off as to perform the current cycle estimation based on equation (5). If the data from the last key-off is unavailable, indicative of an error state (e.g. due to a battery power disconnect when the vehicle is shut down), the process proceeds to operation 310 and the system controller 150 takes protective measures by decreasing the battery power output from the traction battery 124. In addition, the main contactor temperature for the current cycle may be calculated using the following equation:

T(tⱼ)=min(Tₘₐₓ,T_{REF}(tⱼ)+T_{offset}) (10)

wherein Tₘₐₓ denotes a maximum allowable temperature for the cell tabs 154, 156 without requiring any mitigation measures, and T_{offset} denotes a predefined offset temperature reflecting the correlation between the battery temperature T_{REF} and the cell tab temperature T. In an example, the offset temperature T_{offset} may be known to the system.

At operation 312, the system controller 150 compares the estimated cell tab temperature T with a temperature threshold. As an example, the temperature threshold may be equal to the maximum allowable temperature Tₘₐₓ discussed above. Responsive to the cell tab temperature T as estimated being over the temperature threshold, the process proceeds to operation 316 and the system controller 150 takes mitigation measures by reducing the output power from the battery 124 to reduce the main contactor temperature. Otherwise, if the estimated cell tab temperature T is less than the temperature threshold, the system controller 150 keeps the battery 124 at normal operation without taking the mitigation measures.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a battery including a plurality of cells connected via one or more cell tabs;
a motor; and
a controller programmed to responsive to data describing a temperature of the one or more cell tabs exceeding a threshold, decrease power output from the battery to the motor, wherein the data includes parameters indicative of a cell temperature of one of the plurality of cells, a resistance of the one or more cell tabs, and a thermal resistivity of one or more components other than the one or more cell tabs and the cells.

2. The vehicle of claim 1, wherein the thermal resistivity is based on a distance between a location at which the cell temperature is measured and the one or more cell tabs at which the temperature is estimated.

3. The vehicle of claim 1, wherein the one or more components include a packaging of the battery.

4. The vehicle of claim 1, wherein the one or more components include a ventilation system of the battery.

5. The vehicle of claim 1, wherein the data further include a magnitude of current passing through the one or more cell tabs.

6. The vehicle of claim 1, wherein the data further include a product of the thermal resistivity and the resistance.

7. The vehicle of claim 1, wherein the data further include a parameter indicative of a coefficient of thermal decay of the one or more cell tabs.

8. A method comprising:
altering an amount of power output from a traction battery of a vehicle according to a resistance of one or more cell tabs of battery cells of the traction battery, current passing through the one or more cell tabs, a temperature, and a distance between a location at which the temperature is measured and the one or more cell tabs.

9. The method of claim 8, wherein the temperature is associated with at least one cell of the traction battery.

10. The method of claim 8 further comprising altering the power output according to a thermal resistivity of one or more components other than the one or more tabs and cells of the traction battery.

11. The method of claim 8, wherein the one or more components include a packaging of the traction battery or a ventilation system of the traction battery.

12. A power system for a vehicle, comprising:
a controller programmed to alter an amount of power output from a traction battery according to a magnitude of current passing through a tab of a cell of the traction battery, a temperature, and a distance between a location at which the temperature is measured and the tab.

13. The power system of claim 12, wherein the controller is further programmed to alter the amount according to a thermal resistivity of one or more components other than the tab and cell.

14. The power system of claim 13, wherein the one or more components include a packaging of the traction battery.

15. The power system of claim 13, wherein the one or more components include a ventilation system of the traction battery.

16. The power system of claim 13, wherein the magnitude, the temperature, and the distance are indicative of a temperature of the tab.

17. The power system of claim 13, wherein the controller is further programmed to alter the amount according to a parameter indicative of a coefficient of thermal decay of the tab.
